(19) United States
(12) Patent Application Publication
(10) Pub. No.: US 2008/0222109 A1
(43) Pub. Date: Sep. 11, 2008

(54) TIME-SERIES PATTERN FINDING APPARATUS, METHOD AND PROGRAM

(75) Inventor: Shigeaki Sakurai, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/021,747

(22) Filed: Jan. 29, 2008

(30) Foreign Application Priority Data
Mar. 9, 2007 (JP) 2007-060666

(51) Int. Cl. G06F 17/30

(52) U.S. Cl. 707/3; 707/E17.014

(57) ABSTRACT

A time-series pattern finding apparatus, includes decomposing unit decomposing a condition, which indicates a condition of time-series relationship between first elements each defined as including first events each including an attribute and an attribute value of the attribute, into a partial condition, determining unit determining whether the partial condition holds for each potential events, each potential characteristic event sets, and each potential time-series patterns, calculating unit calculating frequency of occurrence in the time-series data items only for fourth events in the potential events, first sets in the potential characteristic event sets, and first patterns in the potential time-series patterns, which satisfy the partial condition, and extracting unit extracting a potential event, a potential event set and a potential time-series pattern from the fourth events, the first sets and the first patterns, respectively, based on the frequency of occurrence not less than a threshold value, as a time-series pattern.

### CROSS-REFERENCE TO RELATED APPLICATIONS

This application is based upon and claims the benefit of priority from prior Japanese Patent Application No. 2007-060666, filed Mar. 9, 2007, the entire contents of which are incorporated herein by reference.

### BACKGROUND OF THE INVENTION

1. Field of the Invention

The present invention relates to a time-series pattern finding apparatus, method and program of finding a time-series pattern from time-series data.

2. Description of the Related Art

There are many time-series data which are made by arranging sets of events indicating a specific subject, and behavior and impression thereof in chronological order. In these time-series data, a time-series pattern by which occurrence of another event set is foreseen is embedded, following occurrence of a specific event set. Therefore, a demand for finding time-series patterns has increased.

For example, in the conventional art, a small time-series pattern is found first, and small time-series patterns are combined. Thereby, a potential time-series pattern is generated and evaluated, and thereby a time-series pattern is effectively found (for example, refer to “Mining Sequential Patterns”, (R. Agrawal and R. Srikant, Proc. Of the 11^{th} Int. Conf. Data Engineering, 3-14, 1995)).

However, if the number of events forming time-series data is large, the number of potential time-series patterns to be generated becomes too large. Therefore, it is necessary to reduce the number of potential time-series patterns, to find a time-series pattern within a time required for practical use.

In finding based on a prior art, it is necessary to reduce the number of potential time-series patterns by limiting objective events in advance or setting a strict evaluation value used for evaluation of potential time-series patterns. Further, in a prior art, it is impossible to find a time-series pattern for tracking change between a plurality of attributes.

### BRIEF SUMMARY OF THE INVENTION

In accordance with an aspect of the invention, there is provided a time-series pattern finding apparatus, comprising: a decomposing unit configured to decompose a time-series constraint condition, which indicates a condition of time-series relationship between first elements each defined as including one or more first events each including an attribute and an attribute value of the attribute, into a partial time-series constraint condition which is generated by combining the first events, the attribute being a property indicating a characteristic of data; a determining unit configured to determine whether the partial time-series constraint condition holds for each of potential events, for each of potential characteristic event sets, and for each of potential time-series patterns, the potential events being extracted from one of time-series data items indicating the time-series relationship, the potential characteristic event sets being generated from characteristic event sets and formed of plural second events, number of the second events being more than number of third events included in the characteristic event sets, the potential time-series patterns being generated from time-series patterns and formed of plural second elements, the number of second elements being more than the number of third elements included in the potential time-series patterns; a calculating unit configured to calculate frequency of occurrence in the time-series data items only for fourth events in the potential events, first sets in the potential characteristic event sets, and first patterns in the potential time-series patterns, the fourth events, the first sets, and the first patterns satisfying the partial time-series constraint condition; and an extracting unit configured to extract a potential event, a potential event set and a potential time-series pattern from the fourth events, the first sets and the first patterns, respectively, the potential event, the potential event set and the potential time-series pattern having an evaluation value based on the frequency of occurrence not less than a threshold value, as a time-series pattern.

In accordance with another aspect of the invention, there is provided a time-series pattern finding apparatus, comprising: a constraint condition storage unit configured to store, as a time-series constraint condition, a time-series relationship between first elements, each of which is defined as including one or more first events each including an attribute and an attribute value of the attribute, the attribute being a property indicating a characteristic of data; a decomposing unit configured to decompose the time-series constraint condition into a plurality of partial constraint conditions in a time-series manner; a data storage unit configured to store a plurality of time-series data items, each of which indicates the time-series relationship; a first extracting unit configured to extract a second event from one of the time-series data items; a first calculating unit configured to calculate a first rate of inclusion of the second event in each of the time-series data items when an attribute value included in the second event is included in the partial constraint conditions; a second extracting unit configured to extract the second event as a characteristic event when the first rate is not less than a threshold value; a characteristic event storage unit configured to store all characteristic events extracted for all the time-series data items stored in the data storage unit; a first selecting unit configured to select two characteristic event sets including a first event number from the characteristic events; a first generating unit configured to generate a potential characteristic event set including all characteristic events included in the two characteristic event sets, when the two characteristic event sets partly match and do not completely match; a second calculating unit configured to calculate a second rate of inclusion of the potential characteristic event set in each of the time-series data items; a third extracting unit configured to extract, as a first time-series pattern, the potential characteristic event set when the second rate is not less than a threshold value; a pattern storage unit configured to store the first time-series pattern to obtain first time-series patterns; a determining unit configured to determine whether second time-series patterns each having a second event number obtained by adding 1 to the first event number and having a first element number are included in the pattern storage unit when a third time-series pattern having a third event number larger than the first event number by 1 and having the first element number is not included in the pattern storage unit; a second selecting unit configured to select, from the first time-series patterns, two time-series patterns each having the second event number and having the first element number when the determining unit determines that the second time-series patterns are included; a second generating unit configured to generate a potential time-series pattern obtained by adding a last element of one time-series patterns to the other time-series pattern of the two time-series patterns when the two time-series patterns partly match and do not completely match; and a third calculating unit configured to calculate a third rate of inclusion of the potential time-series pattern in each of the time-series data items when the potential time-series pattern corresponds to the partial constraint conditions, wherein the potential time-series pattern is extracted as the first time-series pattern and stored in the pattern storage unit, when the third rate is not less than a threshold value, and processing performed by the determining unit, the second selecting unit, the second generating unit, and the third calculating unit is performed for a fourth time-series pattern of a second element number obtained by 1 to the first element number, and third time-series patterns for all element numbers are stored in the pattern storage unit.

### BRIEF DESCRIPTION OF THE SEVERAL VIEWS OF THE DRAWING

FIG. 1 is a block diagram for a time-series pattern finding apparatus according to an embodiment.

FIG. 2 is a flowchart illustrating an example of operation of the time-series pattern finding apparatus of FIG. 1.

FIG. 3 is a diagram illustrating an example of events forming time-series data.

FIG. 4 is a diagram illustrating an example of a time-series constraint condition.

FIG. 5 is a diagram illustrating an example of partial time-series constraint conditions which are generated by a time-series constraint condition decomposing section of FIG. 1 from the condition of FIG. 4 in step S202.

FIG. 6 is a diagram illustrating an example of partial time-series constraint conditions which are generated by the time-series constraint condition decomposing section of FIG. 1 from the upper part of the condition of FIG. 5 in step S202.

FIG. 7 is a diagram illustrating an example of partial time-series constraint conditions which are generated by the time-series constraint condition decomposing section of FIG. 1 from the lower part of the condition of FIG. 5 in step S202.

FIG. 8 is a diagram illustrating an example of partial time-series constraint conditions which are generated by the time-series constraint condition decomposing section of FIG. 1 from the upper portion of the condition of FIG. 6 in step S202.

FIG. 9 is a diagram illustrating an example of partial time-series constraint conditions which are generated by the time-series constraint condition decomposing section of FIG. 1 from the lower portion of the condition of FIG. 6 in step S202.

FIG. 10 is a diagram illustrating an example of partial time-series constraint conditions which are generated by the time-series constraint condition decomposing section of FIG. 1 from the lower portion of the condition of FIG. 7 in step S202.

FIG. 11 is a diagram illustrating an example of partial time-series constraint conditions which are not processed.

FIG. 12 is a diagram illustrating an example of partial time-series constraint conditions set in the time-series constraint condition decomposing section of FIG. 1.

FIG. 13 is a diagram illustrating an example of time-series data items stored in a time-series data storing section of FIG. 1.

FIG. 14 is a diagram illustrating an example of time-series patterns stored in a time-series pattern storing section of FIG. 1.

FIG. 15 is a diagram illustrating an example of time-series patterns stored in the time-series pattern storing section of FIG. 1 in step S217.

FIG. 16 is a diagram illustrating an example of time-series patterns stored in the time-series pattern storing section of FIG. 1 in step S225.

FIG. 17 is a diagram illustrating an example of a time-series pattern stored in the time-series pattern storing section of FIG. 1 in step S225.

### DETAILED DESCRIPTION OF THE INVENTION

A time-series pattern finding apparatus, method and program according to an embodiment of the present invention are described in detail below with reference to the drawings.

According to a time-series pattern finding apparatus, method and program of the embodiment, a time-series pattern for tracking a change between a plurality of attributes can be effectively found at high speed, without limiting the number of objective events or setting an evaluation value to a small value.

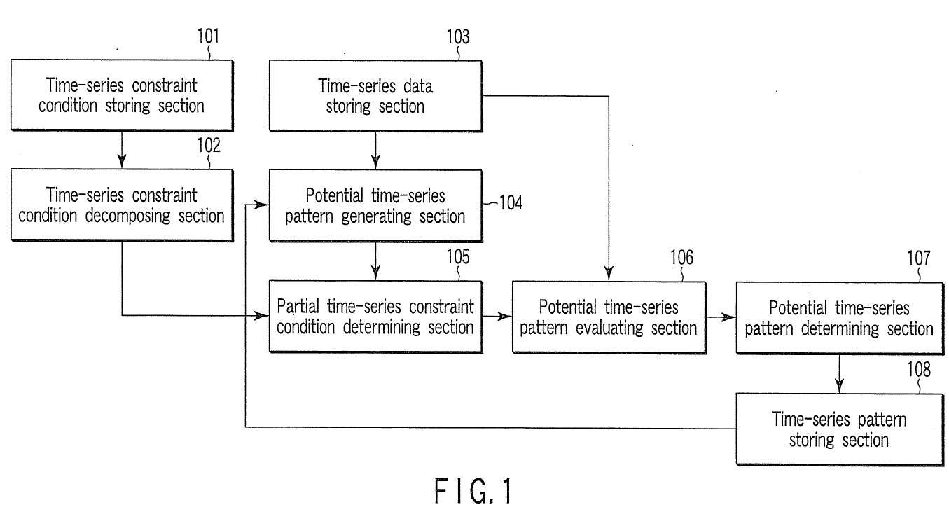

As illustrated in FIG. 1, a time-series pattern finding apparatus according to the embodiment comprises a time-series constraint condition storing section 101, a time-series constraint condition decomposing section 102, a time-series data storing section 103, a potential time-series pattern generating section 104, a partial time-series constraint condition determining section 105, a potential time-series pattern evaluating section 106, a potential time-series pattern determining section 107, and a time-series pattern storing section 108.

The time-series constraint condition storing section 101 stores time-series constraint conditions, each of which indicates a sequential relationship between a plurality of elements. Each element is defined as including one or more events, and each event includes an attribute being a property indicating a characteristic of data and an attribute value of the attribute. An example of the time-series constraint condition is explained later with reference to FIG. 4.

The time-series constraint condition decomposing section 102 takes out one unextracted time-series constraint condition from the time-series constraint conditions stored in the time-series constraint condition storing section 101, decomposes the extracted time-series constraint condition, and generates partial time-series constraint conditions which are smaller than the time-series constraint condition and included in the time-series constraint condition. Further, the time-series constraint condition decomposing section 102 stores the generated partial time-series constraint conditions in the time-series constraint condition storing section 101, as an unextracted time-series constraint condition. For example, if the unextracted time-series constraint condition is formed of two or more elements, the time-series constraint conditions is separated into an element set formed of the last two elements and an element set formed of the other elements. Then, the time-series constraint condition decomposing section 102 generates a partial time-series constraint condition obtained by arranging the other elements and one of the last two elements in order, and a partial time-series limitation obtained by arranging the other elements and the other of the last two elements in order. Thereafter, the two partial time-series limitations are stored as unextracted time-series constraint conditions in the time-series constraint condition storing section 101. Further, if the unextracted time-series constraint condition is formed of one element, the time-series constraint condition decomposing section 102 separates the time-series constraint condition into an event set formed of the last two events and an event set formed of the other events, generates a partial time-series constraint condition obtained by combining the event set of the other events and one of the last two events, and a partial time-series limitation obtaining by combining the other events and the other of the last two events. Then, the time-series constraint condition decomposing section 102 stores the two partial time-series constraint conditions as unextracted time-series constraint conditions in the time-series constraint condition storing section 101.

The time-series data storing section 103 stores a plurality of time-series data items which are data indicating a time-series (sequential) relationship between elements.

The potential time-series pattern generating section 104 takes out one time-series data item from the time-series data items stored in the time-series data storing section 103, and takes out one unextracted event from the taken time-series data item, and uses it as a potential event.

Further, the potential time-series pattern generating section 104 takes out, as an event set pair, two event sets, which correspond to the designated event number and are a combination of unextracted event sets, from sets of characteristic events stored in the time-series pattern storing section 108. If the two sets partly match each other and do not completely match, the potential time-series pattern generating section 104 generates a potential characteristic event set including all the characteristic events included in the two sets. In other cases, the potential time-series pattern generating section 104 determines that no potential characteristic event set can be generated from the event set pair. The potential time-series pattern generating section 104 determines whether an extracted event set pair satisfies designated Conditions 1 and 2 explained below. If the pair satisfies the conditions, the potential time-series pattern generating section 104 generates a potential characteristic event set, by adding an event located at the end of one event set of the event set pair to the other event set.

Further, if there is no unextracted event set pair corresponding to the designated event number, the potential time-series pattern generating section 104 determines whether there is a time-series pattern formed of events of a number, which is larger than the designated event number by 1, and including one element, in time-series patterns stored in the time-series pattern storing section 108. If there is such a time-series pattern, the potential time-series pattern generating section 104 adds 1 to the designated number of events.

Furthermore, the potential time-series pattern generating section 104 takes out a pair of unextracted time-series patterns as a time-series pattern pair from the time-series patterns having the designated element number. If the two time-series patterns partly match each other and do not completely match, the potential time-series pattern generating section 104 generates a potential time-series pattern obtained by adding the last element of one time-series pattern to the other time-series pattern. The potential time-series pattern generating section 104 determines whether the time-series pattern pair satisfies designated Conditions 3 and 4 explained below. If the pair satisfies the conditions, the potential time-series pattern generating section 104 generates a potential time-series pattern by adding the last element of the second time-series pattern to the first time-series pattern of the time-series patterns. Further, if there is no unextracted time-series pattern pair corresponding to the designated element number, the potential time-series pattern generating section 104 determines whether there is a time-series pattern formed of elements of a number that is larger than the designated element number by 1. If there is such a time-series pattern, the potential time-series pattern generating section 104 adds 1 to the designated element number.

The partial time-series constraint condition determining section 105 applies the extracted potential event to the partial time-series constraint condition set in the partial time-series constraint condition decomposing section 102, and thereby determines whether an attribute value corresponding to the potential event is set therein.

Further, the partial time-series constraint condition determining section 105 applies the generated potential event set to the partial time-series constraint conditions, and determines whether there is a partial time-series constraint condition corresponding to the potential event set.

Further, the partial time-series constraint condition determining section 105 refers to the partial time-series constraint condition set in the time-series constraint condition decomposing section 102, and determines whether the generated potential time-series pattern corresponds to the partial time-series constraint condition.

The potential time-series pattern evaluating section 106 applies the potential event which satisfies the partial time-series constraint condition to the time-series data items stored in the time-series data storing section 103, calculates the number of time-series data items including the potential event, and thereby determines the frequency of occurrence of the potential event. If one time-series data item includes the same events, the number of the events is calculated as 1. Further, the potential time-series pattern evaluating section 106 calculates the support (evaluation value) of the event based on an equation.

Further, the potential time-series pattern evaluating section 106 applies a potential event set which satisfies the partial time-series constraint condition to the time-series data items, and calculates the number of time-series data items including the potential event set as the frequency of occurrence of the potential event set. Further, the potential time-series pattern evaluating section 106 calculates the support of the potential event set by an equation.

Furthermore, the potential time-series pattern evaluating section 106 applies a potential time-series pattern which satisfies the partial time-series constraint condition to the time-series data items, and calculates the number of time-series data items including the potential time-series pattern as the frequency of occurrence of the potential time-series pattern. Then, the potential time-series pattern evaluating section 106 calculates the support of the potential time-series pattern by an equation described below.

The potential time-series pattern determining section 107 compares the support of the event satisfying the partial time-series constraint condition with a minimum support (threshold value) designated in advance, and thereby determines whether the support is equal to or exceeds the designated minimum support. If the support is equal to or exceeds the minimum support, the potential event is determined as a characteristic event, and the potential time-series pattern determining section 107 stores the characteristic event in the time-series pattern storing section 108.

Further, the potential time-series pattern determining section 107 determines whether the support of the potential event set is not less than a designated minimum support. If the support of the potential event set is not less than the minimum support, the potential event set is determined as a characteristic event set, and the potential time-series pattern determining section 107 stores the characteristic event set in the time-series pattern storing section 108.

Further, the potential time-series pattern determining section 107 determines whether the support of the potential time-series pattern is not less than the minimum support. If the support of the potential time-series pattern is not less than the minimum support, the potential time-series pattern is determined as the time-series pattern, and the potential time-series pattern determining section 107 stores the time-series pattern in the time-series pattern storing section 108.

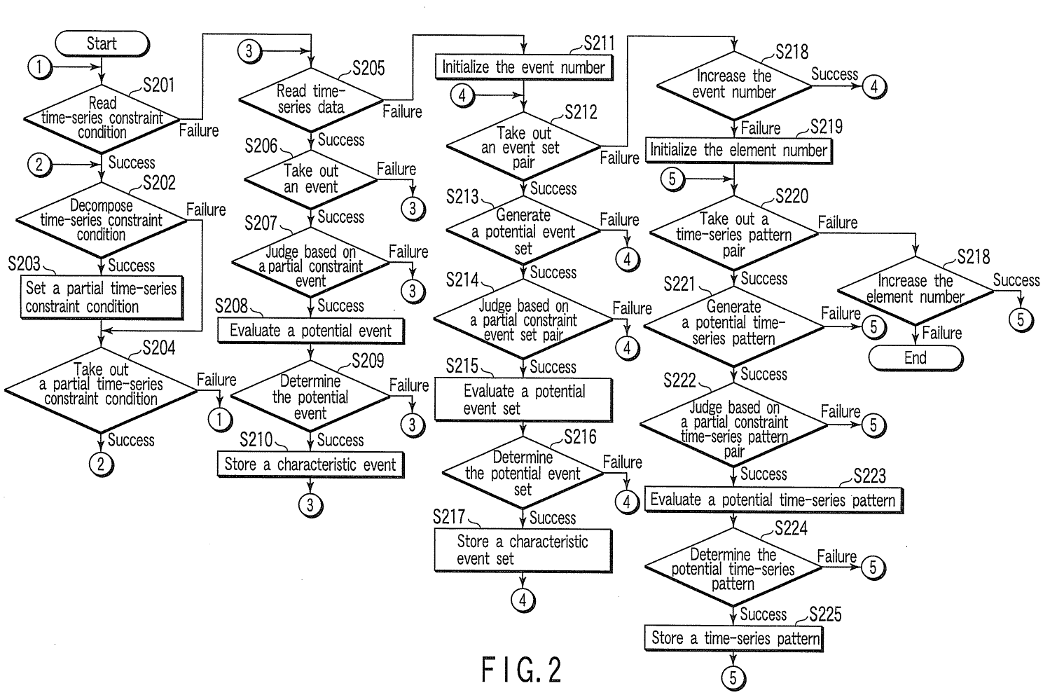

Next, an example of flow of the operation performed by the apparatus of FIG. 1 is explained with reference to FIG. 2.

(Step S201) The time-series constraint condition decomposing section 102 takes out and sets one unextracted time-series constraint condition from the time-series constraint conditions stored in the time-series constraint condition storing section 101. In this step, if there is no time-series constraint condition to be taken out, the apparatus goes to step S205. If there is a time-series constraint condition to be taken out, the apparatus goes to step S202.

(Step S202) The time-series constraint condition decomposing section 102 decomposes the taken time-series constraint condition, and generates smaller partial time-series constraint conditions included in the time-series constraint condition. In this step, if the time-series constraint condition decomposing section 102 succeeds in generating partial time-series constraint conditions, the apparatus goes to step S203. If the time-series constraint condition generating section fails in generation, the apparatus goes to step S204.

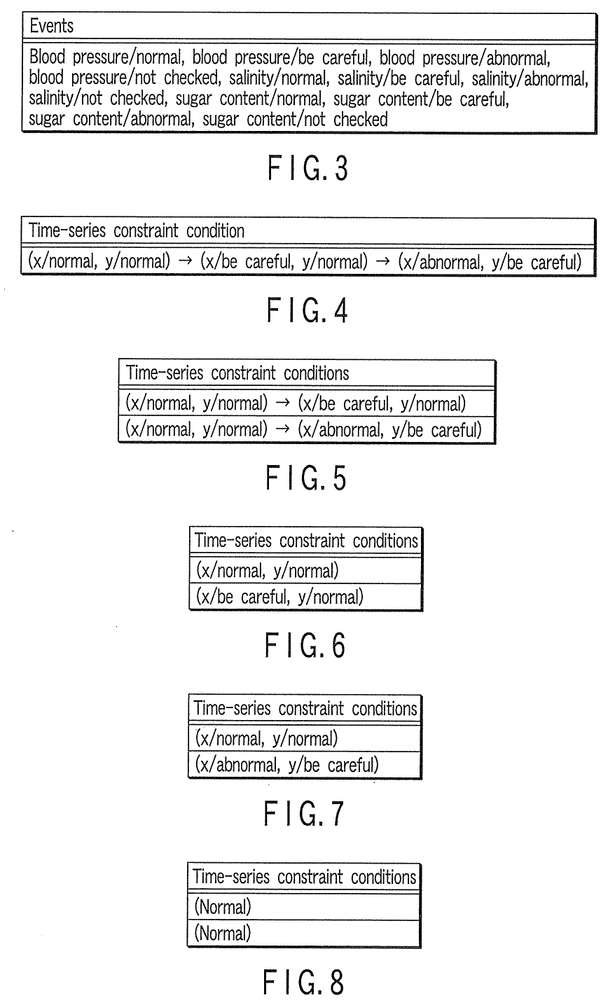

For example, suppose that events forming a time-series data item are provided as illustrated in FIG. 3. In these events, the former part of each event separated by the mark “/” indicates an attribute, and the latter part indicates an attribute value. Each event is formed of an attribute and attribute value pair. The term “attribute” indicates a property which indicates a characteristic of data, and an attribute value indicates a value of a property of specific data. For example, in an event “blood pressure/normal”, the attribute is blood pressure, and the attribute value is “normal”. This event indicates that the data of the blood pressure is normal.

Further, suppose that the time-series constraint condition as illustrated in FIG. 4 is provided. Events put in parentheses indicate events which occurred in the same unit time period, and the mark “→” represents a lapse of time. Therefore, in the example illustrated in FIG. 4, the time-series constraint condition extending over three unit time periods is provided. On the other hand, symbols x and y represent different attributes among provided attributes. Therefore, if the events of FIG. 3 are provided, x and y correspond to two of the attributes “blood pressure”, “salinity” and “sugar content”.

In this step, the time-series constraint condition decomposing section 102 takes out two elements located in a chronologically latter part from the time-series constraint condition. Further, the time-series constraint condition decomposing section 102 generates a partial time-series constraint condition obtained by adding one taken element to the remaining elements, and a partial time-series constraint condition obtained by adding the other taken element to the remaining elements. This is explained with a specific example. The time-series constraint condition illustrated in FIG. 4 is formed of three elements, and thus only the first element is common to two partial time-series constraint conditions. Therefore, the time-series constraint condition decomposing section 102 generates two partial time-series constraint conditions, one of which is formed of the first element and the second element, and the other of which is formed of the first element and the third element, and goes to step S203.

Further, suppose that a time-series constraint condition as illustrated in the upper part of FIG. 5 is provided. In this case, since there is no element common to two partial time-series constraint conditions, the time-series constraint condition decomposing section 102 generates a partial time-series constraint condition formed of the first element, and a partial time-series constraint condition formed of the second element as illustrated in FIG. 6, and goes to step S203. In the same manner, the time-series constraint condition decomposing section 102 generates partial time-series constraint conditions illustrated in FIG. 7 from the time-series constraint condition illustrated in the lower part of FIG. 5.

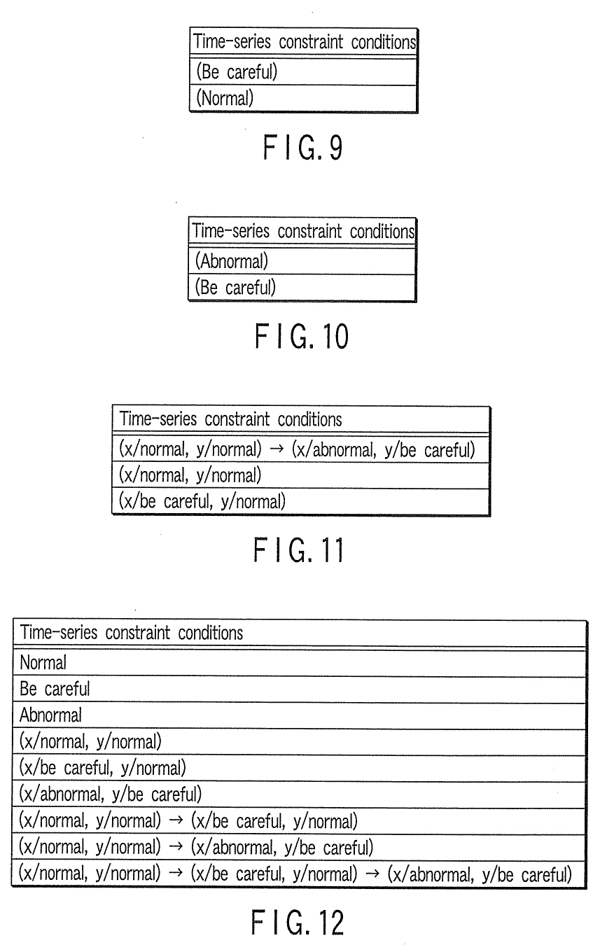

Further, suppose that there is provided a time-series constraint condition as illustrated in the upper part of FIG. 6. In this case, since the time-series constraint condition includes only one element, the time-series constraint condition decomposing section 102 takes out two events located in the latter part from events arranged in an alphabetical order, and generates two partial elements each including one of the taken events and the other events. Since the element of the time-series constraint condition in the upper part of FIG. 6 includes only two events, two partial elements “x/normal” and “y/normal” corresponding to the respective events are generated. Each of these partial elements includes one event, and it is unnecessary to consider the difference in attribute. Therefore, variables x and y contained to express differences in attribute are removed from the partial elements. Therefore, in this case, partial elements as illustrated in FIG. 8 are extracted as partial time-series constraint conditions, and the apparatus goes to step S203. In the same manner, the time-series constraint condition decomposing section 102 extracts partial time-series constraint conditions as illustrated in FIG. 9 from the time-series constraint condition illustrated in the lower part of FIG. 9. Further, the time-series constraint condition decomposing section 102 extracts partial time-series constraint conditions as illustrated in FIG. 10 from the time-series constraint condition illustrated in the lower part of FIG. 7.

On the other hand, when a time-series constraint condition formed of one event is selected, the time-series constraint condition cannot be further decomposed. Therefore, the time-series constraint condition decomposing section 102 determines that decomposition of the time-series constraint condition has failed, and goes to step S204.

(Step S203) The time-series constraint condition decomposing section 102 determines whether the generated partial time-series constraint condition has already been extracted. If it is not extracted, the time-series constraint condition decomposing section 102 sets the partial time-series constraint condition as an unprocessed partial time-series constraint condition.

For example, if the time-series constraint condition illustrated in FIG. 4 is decomposed, the partial time-series constraint conditions in FIG. 5 are generated. Since the partial time-series constraint conditions have not been extracted yet, the time-series constraint condition decomposing section 102 sets the partial time-series constraint conditions as unprocessed partial time-series constraint conditions.

On the other hand, if the time-series constraint condition illustrated in the lower part of FIG. 5 is decomposed, the partial time-series constraint conditions illustrated in FIG. 7 are generated. In this case, if the partial time-series constraint condition in the upper part of FIG. 5 has already been processed, the partial time-series constraint condition “(x/normal, y/normal)” in the upper part of FIG. 7 among the partial time-series constraint conditions of FIG. 7 has already been set. Therefore, the time-series constraint condition decomposing section 102 sets only the partial time-series constraint condition “(x/abnormal, y/be careful)” in the lower part as an unprocessed partial time-series constraint condition.

(Step S204) The time-series constraint condition decomposing section 102 takes one partial time-series constraint condition having the largest number of elements, from the set unprocessed partial time-series constraint conditions, and returns to step S202. If there is no unprocessed partial time-series constraint condition to be taken out, the apparatus returns to step S201.

For example, if the unprocessed time-series constraint conditions are set as illustrated in FIG. 11, the time-series constraint condition decomposing section 102 takes out the partial time-series constraint condition “(x/normal, y/normal)→(x/abnormal, y/be careful)” having the most elements, and returns to step S202.

(Step S205) The potential time-series pattern generating section 104 takes out one time-series data item from the time-series data items stored in the time-series data storing section 103, and goes to step S206. If all the time-series data items stored in the time-series data storing section 103 have been taken out, the apparatus goes to step S211.

(Step S206) The potential time-series pattern generating section 104 takes out one unextracted event from the taken time-series data item, and uses it as a potential event. When there is a potential event to be taken out, the apparatus goes to step S207. If there is no potential event to be taken out, the processing is returned to step S205.

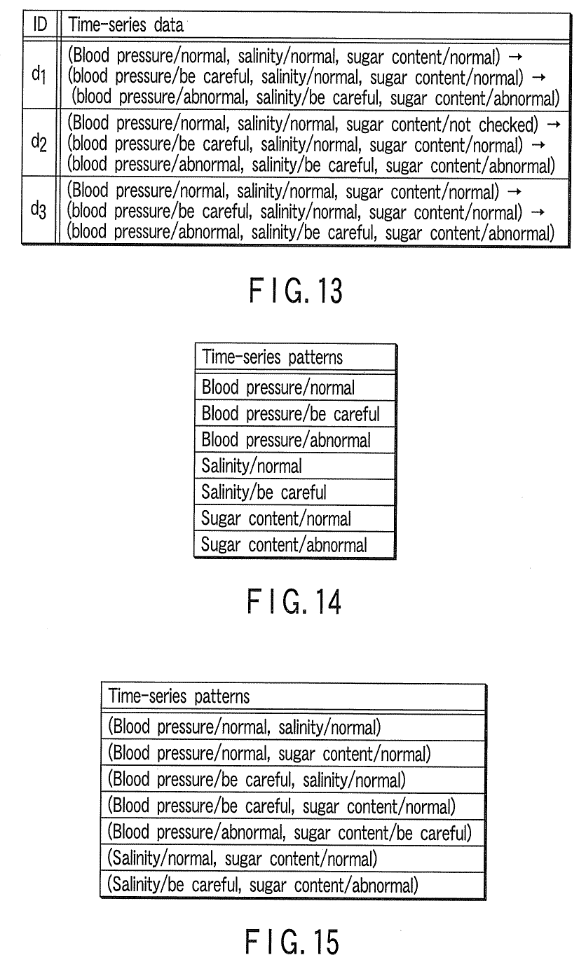

For example, suppose that the time-series data item d₁ of FIG. 13 is read by the potential time-series pattern generating section 104. In this case, when events are successively taken out from the left to the right of the time-series data item, the potential event “blood pressure/normal” is taken out first, and the apparatus goes to step S207. Further, if the step S206 is to be carried out again after the last event “sugar content/abnormal” is taken out, the apparatus goes to step S205.

(Step S207) The partial time-series constraint condition determining section 105 applies the extracted potential event to the partial time-series constraint condition set in the time-series constraint condition decomposing section 102, and thereby determines whether the attribute value corresponding to the potential event is set. If the attribute value is set in the partial time-series constraint condition, the apparatus goes to step S208. If it is not set, the processing is returned to step S205.

For example, suppose that the partial time-series constraint conditions illustrated in FIG. 12 are set as partial time-series constraint conditions, and the event “blood pressure/normal” is taken out as an event. In this case, since the attribute “normal” is set in the partial time-series constraint conditions, the apparatus goes to step S208. On the other hand, if the event “sugar content/not checked” is taken out, since the attribute value “not checked” is not set in the partial time-series constraint conditions, the apparatus returns to step S205.

(Step S208) The potential time-series pattern evaluating section 106 applies a potential event which satisfies the partial time-series constraint condition to the time-series data items stored in the time-series data storing section 103. Thereby, the potential time-series pattern evaluating section 106 calculates the number of time-series data items including the potential event, and determines this as the frequency of occurrence of the potential event. Even when a time-series data item includes a plurality of the same events, the number of events included in the time-series data item is calculated as 1. Further, the potential time-series pattern evaluating section 106 calculates the support of the event based on the following equation (1).

Support=frequency of occurrence of the event/the number of time-series data items (1)

For example, suppose that the time-series data items of FIG. 13 are stored in the time-series data storing section 103, and the event “blood pressure/normal” is provided as the event satisfying the partial time-series constraint condition. In this case, since each of the time-series data items includes the event, the frequency of occurrence of the event is 3. Further, the number of time-series data items is 3, and thus the support of the event is 1.0 (=3/3).

On the other hand, if the event “salinity/abnormal” is provided as the event satisfying the partial time-series constraint condition, there is no time-series data item including the event, and thus the frequency of occurrence of the event is 0. Therefore, the support of the event is 0.0 (=0/3).

(Step S209) The potential time-series pattern determining section 107 compares the support of the event satisfying the partial time-series constraint condition with the minimum support designated in advance, and determines whether the support is not less than the designated minimum support. If the support is not less than the minimum support, the potential time-series pattern determining section 107 determines the potential event as a characteristic event, and goes to step S210. If the support is less than the minimum support, the apparatus returns to the step S205.

For example, supposing that the minimum support 0.9 is provided and the event “blood pressure/normal” is provided as an event satisfying the partial time-series constraint condition, the support of the event is 1.0, and exceeds 0.9. Therefore, the potential time-series pattern determining section 107 determines the event as a characteristic event, and goes to step S210. On the other hand, if the event “salinity/abnormal” is provided as an event satisfying the partial time-series constraint condition, the support of the event is 0 and is smaller than 0.9. Therefore, the apparatus returns to step S205.

(Step S210) The potential time-series pattern determining section 107 stores the characteristic event in the time-series pattern storing section 108. For example, the characteristic events illustrated in FIG. 14 are stored in the time-series pattern storing section 108 as time-series patterns each having one event.

(Step S211) The potential time-series pattern generating section 104 sets, for example, 1 as an initial value of the number of events.

(Step S212) The potential time-series pattern generating section 104 takes out, as an event set pair, two event sets corresponding to the designated number of events and being a combination of unextracted event sets, from the characteristic event sets stored in the time-series pattern storing section 108. The same event set can be taken out twice as an event set pair. If an event set pair is extracted, the apparatus goes to step S213. If no event set pair is extracted, the apparatus goes to step S218.

(Step S213) The potential time-series pattern generating section 104 determines whether the extracted event set pair satisfies the following Conditions 1 and 2. If the pair satisfies the conditions, the potential time-series pattern generating section 104 generates a potential event set by adding the event located at the end of one of the event sets to the other event set of the event set pair, and goes to step S214. If the pair does not satisfy the conditions, the apparatus returns to step S212.

Condition 1: the other event partial sets except for the event located at the end of each event set are the same between the event sets.

Condition 2: the attribute of the event located at the end of each event set is not the same as the other events.

The attributes of the events included in an event set are arranged on the basis of a standard such as an alphabetical order, and a characteristic event formed of one event is a special example of a characteristic event set.

For example, suppose that the attributes are arranged in the order “blood pressure, salinity, sugar content”. In this case, suppose that 1 is provided as the number of events, and event sets “blood pressure/normal” and “salinity/normal” each including one event are provided as an event set pair. If the event number is 1, Condition 1 is always satisfied. In addition, the attributes of the event set pair are “blood pressure” and “salinity”, which are different from each other, and the Condition 2 is also satisfied. Therefore, “(blood pressure/normal, salinity/normal)” is generated as a potential event set, and the apparatus goes to step S214.

Further, suppose that the number of events is 2, and the event sets “blood pressure/normal, salinity/normal)” and “(blood pressure/normal, sugar content/normal)” each having two events are provided as an event set pair. In the event set pair, the event sets excluding the second event have the same event partial set “blood pressure/normal”, and the attributes of the second events of the event sets are “salinity” and “sugar content”, which are different from each other. Therefore, the Conditions 1 and 2 are satisfied. Therefore, “(blood pressure/normal, salinity/normal, sugar content/normal)” is obtained as a potential event set, and the apparatus goes to step S214.

On the other hand, suppose that 2 is provided as the number of events, the event sets “(blood pressure/normal, salinity/normal)” and “(blood pressure/be careful, salinity/normal)” each including two events are provided as an event set pair. In the event set pair, the event sets excluding the second event have events “blood pressure/normal” and “blood pressure/be careful”, which are not the same, and the Condition 1 is not satisfied. Therefore, no potential event set is generated, and the apparatus returns to step S212.

Further, suppose that the number of events is 2, and the event sets “(blood pressure/normal, salinity/normal)” and “(blood pressure/normal, salinity/normal)” each including two events are provided as an event set pair. In the event set pair, the attributes of both the second events of the event sets are “salinity”, and the Condition 2 is not satisfied. Therefore no potential event set is generated, and the apparatus returns to step S212.

(Step S214) The partial time-series constraint condition determining section 105 applies the generated potential event set to the partial time-series constraint conditions, and determines whether there is a partial time-series constraint condition corresponding to the potential event set. If there is such a partial time-series constraint condition, the apparatus goes to step S215. If there is not, the apparatus returns to step S212.

For example, if the potential event set “(blood pressure/normal, salinity/normal)” is provided, the potential event set matches the partial time-series constraint condition “(x/normal, y/normal)” in FIG. 12. Therefore, the apparatus goes to step S215.

On the other hand, if the potential event set “(blood pressure/normal, sugar content/abnormal)” is provided, no corresponding partial time-series constraint condition exists in FIG. 12, and thus the apparatus returns to step S212. Further, if the potential event set “(blood pressure/normal, salinity/normal, sugar content/normal)” is provided, no corresponding partial time-series constraint condition exists in FIG. 12, and thus the apparatus returns to step S212.

(Step S215) The potential time-series pattern evaluating section 106 applies the generated potential event set to the time-series data items, and calculates the number of time-series data items including the potential event set as the frequency of occurrence of the potential event set. Further, the potential time-series pattern evaluating section 106 calculates the support of the potential event set based on the equation (1).

For example, if the potential event set “(blood pressure/normal, salinity/normal)” is provided, each of the time-series data items in FIG. 13 includes the potential event set, and the frequency of occurrence of the potential event set is 3. Further, the support thereof is 1.0 (=3/3).

On the other hand, if the potential event set “(blood pressure/normal, sugar content/abnormal)” is provided, none of the time-series data items in FIG. 13 include the potential event set, and the frequency of occurrence thereof is 0. Further, the support thereof is 0.0 (=0/3).

(Step S216) The potential time-series pattern determining section 107 determines whether the support of the potential event set is not less than the designated minimum support. If the support is not less than the minimum support, the potential time-series pattern determining section 107 determines the potential event set as a characteristic event set, and goes to step S217. If the support is less than the minimum support, the apparatus returns to the step S212.

For example, supposing that the event set “(blood pressure/normal, salinity/normal)” is provided as the potential event set, the support of the potential event set calculated in the same manner as step S209 is 1.0, and exceeds 0.9 being the minimum support. Therefore, the potential time-series pattern determining section 107 determines the potential event set as a characteristic event set, and goes to step S217.

On the other hand, if the event set “(salinity/abnormal, sugar content/abnormal)” is provided as a potential event set, the support of the potential event set calculated in the same manner as step S209 is 0.0 and is smaller than 0.9 being the minimum support. Therefore, the apparatus returns to step S212.

(Step S217) The potential time-series pattern determining section 107 stores the characteristic event set in the time-series pattern storing section 108.

For example, the characteristic event sets illustrated in FIG. 15 are stored in the time-series pattern storing section 108, as time-series patterns, each of which has an element number of 1 and event number of 2.

(Step S218) The potential time-series pattern generating section 104 determines whether the time-series patterns stored in the time-series pattern storing sections 108 include a time-series pattern, which has an element number of 1 and is formed of events of a number larger than the designated event number by 1. If there is such a time-series pattern, the potential time-series pattern generating section 104 adds 1 to the designated number of events, and returns to step S212. If there is not, the apparatus goes to step S219.

(Step S219) The potential time-series pattern generating section 104 sets, for example, 1 as an initial value of the element number.

(Step S220) The potential time-series pattern generating section 104 takes out a pair of unextracted time-series patterns as a time-series pattern pair from time-series patterns having the designated element number. If there is no time-series pattern pair to be taken out, the apparatus goes to step S226. If there is a time-series pattern pair to be taken out, the apparatus goes to step S221. Two time-series patterns taken out can be the same time-series pattern. Further, pairs of time-series patterns having the same time-series patterns taken out in different orders are regarded as different time-series pattern pairs.

(Step S221) The potential time-series pattern generating section 104 determines whether the time-series pattern pair satisfies the following Conditions 3 and 4. If the pair satisfies the conditions, the potential time-series pattern generating section 104 generates a potential time-series pattern by adding the last element of the second time-series pattern to the first time-series pattern of the time-series patterns, and goes to step S222. If the pair does not satisfy the conditions, the apparatus returns to step S220.

Condition 3: The partial time-series patterns of the two time-series patterns match each other except for the last element.

Condition 4: The attribute sets of the events included in the last elements of the two time-series patterns match each other.

For example, suppose that two time-series patterns “(blood pressure/normal, salinity/normal)” and “(blood pressure/be careful, salinity/normal)”, each having an element number of 1, are taken out as a time-series pattern pair. When the element number of each time-series pattern is 1, the Condition 3 is always satisfied. In addition, both the attribute sets of the events included in the last elements of the time-series patterns are “blood pressure, salinity”, and the Condition 4 is satisfied. Therefore, a potential time-series pattern “(blood pressure/normal, salinity/normal)→(blood pressure/be careful, salinity/normal)” is generated from the time-series pattern pair, and the operation goes to step S222.

Further, suppose that two time-series patterns “(blood pressure/normal, salinity/normal)→(blood pressure/be careful, salinity/normal)” and “blood pressure/normal, salinity/normal)→(blood pressure/abnormal, salinity/be careful)”, each of which has an element number of 2, are taken out as a time-series pattern pair. In the time-series pattern pair, the time-series patterns have the same partial time-series pattern “(blood pressure/normal, salinity/normal)”, except for the last element, and the Condition 3 is satisfied. Further, the attribute sets of the events included in the last elements of the time-series patterns are “blood pressure, salinity” and match each other, and thus the Condition 4 is satisfied. Therefore, a potential time-series pattern “(blood pressure/normal, salinity/normal)→(blood pressure/be careful, salinity/normal)→(blood pressure/abnormal, salinity/be careful)” is generated from the time-series pattern pair, and the operation goes to step S222.

On the other hand, suppose that two time-series patterns “(blood pressure/normal, salinity/normal)” and “(blood pressure/be careful, sugar content/normal)”, each of which has an event number of 1, are taken out as a time-series pattern pair. In the time-series pattern pair, the attribute sets of the events included in the last elements of the two time-series patterns are “blood pressure, salinity” and “blood pressure, sugar content”, which are different from each other, and thus the Condition 4 is not satisfied. Therefore, the apparatus returns to step S220.

(Step S222) The partial time-series constraint condition determining section 105 refers to the partial time-series constraint conditions set in the time-series constraint condition decomposing section 102, and determines whether the generated potential time-series pattern corresponds to the partial time-series constraint conditions. If there is a corresponding partial time-series constraint condition, the apparatus goes to step S223. If there is not, the apparatus returns to step S220.

For example, if the potential time-series pattern “(blood pressure/normal, salinity/normal)→(blood pressure/be careful, salinity/normal)” is generated, the potential time-series pattern matches the partial time-series constraint condition “(x/normal, y/normal) →(x/be careful, y/normal)” in the partial time-series constraint conditions of FIG. 12. Therefore, the operation goes to step S223.

On the other hand, if the potential time-series pattern “(blood pressure/normal, salinity/normal)→(blood pressure/normal, salinity/normal)” is generated, no partial time-series constraint condition corresponding to the potential time-series pattern exists in FIG. 12. Therefore, the operation returns to step S220.

(Step S223) The potential time-series pattern evaluating section 106 determines the number of time-series data items including the potential time-series pattern as the frequency of occurrence of the potential time-series pattern, and calculates the support of the potential time-series pattern by the equation (1).

For example, if the potential time-series pattern “(blood pressure/normal, salinity/normal)→(blood pressure/be careful, salinity/normal)” is provided, the potential time-series pattern is included in each of the time-series data items of FIG. 13, and thus the frequency of occurrence thereof is 3. Further, the support of the potential time-series pattern is 1.0 (=3/3).

Further, if the potential time-series pattern “(blood pressure/normal, sugar content/normal)→(blood pressure/be careful, sugar content/normal)” is provided, the potential time-series pattern is included in the time-series data items d₁ and d₃ of FIG. 13, and thus the frequency of occurrence thereof is 2.

Further, the support of the potential time-series pattern is 0.67 (=2/3).

(Step S224) The potential time-series pattern determining section 107 determines whether the support of the potential time-series pattern is not less than the minimum support. If the support of the potential time-series pattern is not less than the minimum support, the potential time-series pattern is determined as the time-series pattern, and the apparatus goes to step S225. If the support is smaller than the minimum support, the apparatus returns to step S220.

For example, in the case of the potential time-series pattern “(blood pressure/normal, salinity/normal)→(blood pressure/be careful, salinity/normal)”, the support thereof is 1.0 and exceeds 0.9 being the minimum support. Therefore, the potential time-series pattern is determined as the time-series pattern, and the operation goes to step S225.

On the other hand, in the case of the potential time-series pattern “(blood pressure/normal, sugar content/normal)→(blood pressure/be careful, sugar content/normal)”, the support thereof is 0.67 and is smaller than 0.9 being the minimum value. Therefore, the apparatus returns to step S220.

(Step S225) The potential time-series pattern determining section 107 stores the time-series pattern in the time-series pattern storing section 108, and returns to step S220.

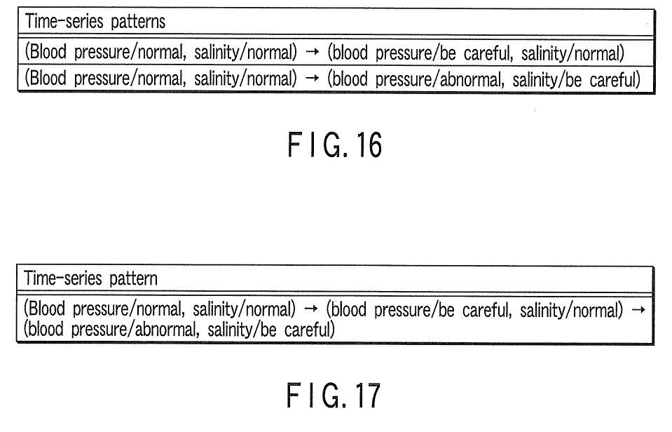

For example, the time-series patterns illustrated in FIG. 16 are stored as time-series patterns each having an event number of 2. Further, the time-series patterns illustrated in FIG. 17 are stored as time-series patterns each having an event number of 3.

(Step S226) The potential time-series pattern generating section 104 determines whether there is a time-series pattern formed of elements of a number that is larger than the designated element number by 1. If there is such a time-series pattern, the potential time-series pattern generating section 104 adds 1 to the designated number of elements, and returns to step S220. If there is not, the processing is ended.

By performing the above processing, it is possible to find all the time-series patterns that satisfy the designated time-series constraint condition and have the support not less than the minimum support. Specifically, for example, the time-series pattern illustrated in FIG. 17 can be found from the time-series data items of FIG. 13, as a time-series pattern which satisfies the time-series constraint condition of FIG. 4 and has the support not less than 0.9 being the minimum support.

As described above, according to the present invention, it is possible to efficiently find a time-series pattern including a structure interesting to the user at high speed, in a method of finding a time-series pattern from time-series data items formed of events characterized by attributes and attribute values.

The time-series pattern finding apparatus based on time-series constraint conditions is not limited to the above embodiment. For example, the support is used in the above embodiment to determine whether a potential event, a potential event set, and a potential time-series pattern can be regarded as a characteristic event, a characteristic event set, and a time-series pattern, respectively. However, it is possible to use the sequential interestingness instead disclosed in the reference “Sequential Mining Method based on a New Criterion”, (Shigeaki Sakurai, Youichi Kitahara, and Ryohei Orihara, Proc. The 10^{th} IASTED Int. Conf. on Artificial Intelligence and Soft Computing, 544-045, 2006).

Further, in the above embodiment, although the time-series constraint condition stored in the time-series constraint condition storing section 101 is limited to 1, it is possible to set a plurality of time-series constraint conditions. Further, although the number of elements in the time-series constraint condition and the number of events included in each element are set to 3 and 2, respectively, they may be any natural numbers. In addition, although the attribute values of attributes forming events are set to the same values, it is possible to adopt the same values for only part of the attribute values, and designate an entirely different attribute value for a specific attribute. Further, other various modifications can be performed within a range not departing from the gist of the present invention to form a time-series pattern finding apparatus based on time-series constraint conditions.

According to the above embodiment, it is possible to greatly reduce the number of evaluations of the frequency of occurrence using time-series data, which are necessary for potential time-series patterns, by performing determination based on partial time-series constraint conditions, and it is possible to find a time-series pattern within a time period required for practical use. Further, since a time-series relationship between attribute values in a plurality of attributes is considered, it is possible to find a time-series pattern including relationship between attribute values of a plurality of attributes. In addition, since it is possible to find only a time-series pattern having a structure to which the user pays attention, it is possible to avoid finding a number of time-series patterns which are not interesting to the user.

The flow charts of the embodiments illustrate methods and systems according to the embodiments of the invention. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A time-series pattern finding apparatus, comprising:
a decomposing unit configured to decompose a time-series constraint condition, which indicates a condition of time-series relationship between first elements each defined as including one or more first events each including an attribute and an attribute value of the attribute, into a partial time-series constraint condition which is generated by combining the first events, the attribute being a property indicating a characteristic of data;
a determining unit configured to determine whether the partial time-series constraint condition holds for each of potential events, for each of potential characteristic event sets, and for each of potential time-series patterns, the potential events being extracted from one of time-series data items indicating the time-series relationship, the potential characteristic event sets being generated from characteristic event sets and formed of plural second events, number of the second events being more than number of third events included in the characteristic event sets, the potential time-series patterns being generated from time-series patterns and formed of plural second elements, the number of second elements being more than the number of third elements included in the potential time-series patterns;
a calculating unit configured to calculate frequency of occurrence in the time-series data items only for fourth events in the potential events, first sets in the potential characteristic event sets, and first patterns in the potential time-series patterns, the fourth events, the first sets, and the first patterns satisfying the partial time-series constraint condition; and
an extracting unit configured to extract a potential event, a potential event set and a potential time-series pattern from the fourth events, the first sets and the first patterns, respectively, the potential event, the potential event set and the potential time-series pattern having an evaluation value based on the frequency of occurrence not less than a threshold value, as a time-series pattern.

2. A time-series pattern finding apparatus, comprising:
a constraint condition storage unit configured to store, as a time-series constraint condition, a time-series relationship between first elements, each of which is defined as including one or more first events each including an attribute and an attribute value of the attribute, the attribute being a property indicating a characteristic of data;
a decomposing unit configured to decompose the time-series constraint condition into a plurality of partial constraint conditions in a time-series manner;
a data storage unit configured to store a plurality of time-series data items, each of which indicates the time-series relationship;
a first extracting unit configured to extract a second event from one of the time-series data items;
a first calculating unit configured to calculate a first rate of inclusion of the second event in each of the time-series data items when an attribute value included in the second event is included in the partial constraint conditions;
a second extracting unit configured to extract the second event as a characteristic event when the first rate is not less than a threshold value;
a characteristic event storage unit configured to store all characteristic events extracted for all the time-series data items stored in the data storage unit;
a first selecting unit configured to select two characteristic event sets including a first event number from the characteristic events;
a first generating unit configured to generate a potential characteristic event set including all characteristic events included in the two characteristic event sets, when the two characteristic event sets partly match and do not completely match;
a second calculating unit configured to calculate a second rate of inclusion of the potential characteristic event set in each of the time-series data items;
a third extracting unit configured to extract, as a first time-series pattern, the potential characteristic event set when the second rate is not less than a threshold value;
a pattern storage unit configured to store the first time-series pattern to obtain first time-series patterns;
a determining unit configured to determine whether second time-series patterns each having a second event number obtained by adding 1 to the first event number and having a first element number are included in the pattern storage unit when a third time-series pattern having a third event number larger than the first event number by 1 and having the first element number is not included in the pattern storage unit;
a second selecting unit configured to select, from the first time-series patterns, two time-series patterns each having the second event number and having the first element number when the determining unit determines that the second time-series patterns are included;
a second generating unit configured to generate a potential time-series pattern obtained by adding a last element of one time-series patterns to the other time-series pattern of the two time-series patterns when the two time-series patterns partly match and do not completely match; and
a third calculating unit configured to calculate a third rate of inclusion of the potential time-series pattern in each of the time-series data items when the potential time-series pattern corresponds to the partial constraint conditions,
wherein the potential time-series pattern is extracted as the first time-series pattern and stored in the pattern storage unit, when the third rate is not less than a threshold value, and
processing performed by the determining unit, the second selecting unit, the second generating unit, and the third calculating unit is performed for a fourth time-series pattern of a second element number obtained by 1 to the first element number, and third time-series patterns for all element numbers are stored in the pattern storage unit.

3. The apparatus according to claim 2, wherein
the first generating unit generates, as the potential characteristic event set, a set obtained by adding an event located at an end of one set to the other set, when the other event partial sets of two sets match except for events located at an end of the sets and attributes of the events located at an end of the sets do not match.

4. The apparatus according to claim 2, wherein
the second generating unit generates, as the potential time-series pattern, a time-series pattern obtained by adding the last element of one time-series pattern to the other time-series pattern of the two time-series patterns when the partial time-series patterns of the two time-series patterns match except for the last element and attribute sets of the events included in the last element do not match.

5. The apparatus according to claim 2, wherein
the first calculating unit calculates the first rate by the following:
(number of time-series data items including the second event)/(number of time-series data items stored in the data storage unit).

6. The apparatus according to claim 2, wherein
the second calculating unit calculates the second rate by the following:
(number of time-series data items including the potential characteristic event set)/(number of time-series data items stored in the data storage unit).

7. The apparatus according to claim 2, wherein
the third calculating unit calculates the third rate by the following:
(number of time-series data items including the potential time-series pattern)/(number of time-series data items stored in the data storage unit).

8. The apparatus according to claim 2, wherein
the first generating unit starts generation of a potential characteristic event set from case where the first event number is 1.

9. The apparatus according to claim 2, wherein
the first element number is 1.

10. A time-series pattern finding method, comprising:
decomposing a time-series constraint condition, which indicates a condition of time-series relationship between first elements each defined as including one or more first events each including an attribute and an attribute value of the attribute, into a partial time-series constraint condition which is generated by combining the first events, the attribute being a property indicating a characteristic of data;
determining whether the partial time-series constraint condition holds for each of potential events, for each of potential characteristic event sets, and for each of potential time-series patterns, the potential events being extracted from one of time-series data items indicating the time-series relationship, the potential characteristic event sets being generated from characteristic event sets and formed of plural second events, number of the second events being more than number of third events included in the characteristic event sets, the potential time-series patterns being generated from time-series patterns and formed of plural second elements, the number of second elements being more than the number of third elements included in the potential time-series patterns;
calculating frequency of occurrence in the time-series data items only for fourth events in the potential events, first sets in the potential characteristic event sets, and first patterns in the potential time-series patterns, the fourth events, the first sets, and the first patterns satisfying the partial time-series constraint condition; and
extracting a potential event, a potential event set and a potential time-series pattern from the fourth events, the first sets and the first patterns, respectively, the potential event, the potential event set and the potential time-series pattern having an evaluation value based on the frequency of occurrence not less than a threshold value, as a time-series pattern.

11. A time-series pattern finding method, comprising:
storing in a constraint condition storage unit, as a time-series constraint condition, a time-series relationship between first elements, each of which is defined as including one or more first events each including an attribute and an attribute value of the attribute, the attribute being a property indicating a characteristic of data;
decomposing the time-series constraint condition into a plurality of partial constraint conditions in a time-series manner;
storing in a data storage unit a plurality of time-series data items, each of which indicates the time-series relationship;
extracting a second event from one of the time-series data items;
calculating a first rate of inclusion of the second event in each of the time-series data items when an attribute value included in the second event is included in the partial constraint conditions;
extracting the second event as a characteristic event when the first rate is not less than a threshold value;
storing in a characteristic event storage unit all characteristic events extracted for all the time-series data items stored in the data storage unit;
selecting two characteristic event sets including a first event number from the characteristic events;
generating a potential characteristic event set including all characteristic events included in the two characteristic event sets, when the two characteristic event sets partly match and do not completely match;
calculating a second rate of inclusion of the potential characteristic event set in each of the time-series data items;
extracting, as a first time-series pattern, the potential characteristic event set when the second rate is not less than a threshold value;
storing in a pattern storage unit the first time-series pattern to obtain first time-series patterns;
determining whether second time-series patterns each having a second event number obtained by adding 1 to the first event number and having a first element number are included in the pattern storage unit when a third time-series pattern having a third event number larger than the first event number by 1 and having the first element number is not included in the pattern storage unit;
selecting, from the first time-series patterns, two time-series patterns each having the second event number and having the first element number when the determining unit determines that the second time-series patterns are included;
generating a potential time-series pattern obtained by adding a last element of one time-series patterns to the other time-series pattern of the two time-series patterns when the two time-series patterns partly match and do not completely match;
calculating a third rate of inclusion of the potential time-series pattern in each of the time-series data items when the potential time-series pattern corresponds to the partial constraint conditions; and
storing in the pattern storage unit third time-series patterns for all element numbers.
